(19) United States
(12) Patent Application Publication
(10) Pub. No.: US 2017/0111538 A1
(43) Pub. Date: Apr. 20, 2017

(54) IMAGE CAPTURE METHOD

(71) Applicant: TECO IMAGE SYSTEMS CO., LTD., Taipei City (TW)

(72) Inventors: NAI-WUN LUO, Taipei City (TW); KO-MENG CHEN, Taipei City (TW)

(21) Appl. No.: 14/968,579

(22) Filed: Dec. 14, 2015

(30) Foreign Application Priority Data
Oct. 14, 2015 (TW) 104133781

(51) Int. Cl. H04N 1/047; H04N 1/107; H04N 1/00

(52) U.S. Cl. CPC H04N 1/047; H04N 1/00525; H04N 1/107; H04N 1/00925; H04N 1/00384; H04N 2201/0096; H04N 2201/0084

(57) ABSTRACT

An image capture method includes steps of providing an image capture device and a medium, performing an image-capturing operation, moving the image capture device along a first direction on the medium, judging whether the image-capturing operation is performed continuously, moving the image capture device along a second direction on the medium, moving the image capture device along a third direction on the medium, judging whether the image-capturing operation is performed continuously, moving the image capture device along a fourth direction on the medium, and finishing the image-capturing operation. Therefore, not only the number of times and the time taken by the image-capturing operation are significantly reduced and a complete image is captured, but also the position information, which is acquired by an optical mouse sensor, is provided for image synthesis, thereby enhancing the efficiency and the quality of image synthesis.

### FIELD OF THE INVENTION

The present invention relates to an image capture method, and more particularly to an image capture method performed by a large area image capturing within one image-capturing operation along a specific route.

### BACKGROUND OF THE INVENTION

In the modern societies, people are increasingly dependent on handheld devices such as smart phones or tablet computers. Consequently, the demands on digitalized documents become stronger. After paper-type documents are digitalized through an imaging capturing process such as a scanning process or photographing process, the documents are converted into digital files.

Generally, in case that the imaging capturing process is the scanning process, the imaging quality is better. Under this circumstance, the characters in the image can be recognized more easily. Nowadays, various kinds of scanners have been introduced into the market. For example, the widely-used scanners include flatbed scanners or handy scanners.

Compared to the flatbed scanner, the volume of the handy scanner is smaller and lighter, and is more convenient to be carry with. It is called as one operation during starting an image-capturing operation after pressing the scanning button, and finishing the image-capturing operation until pressing the scanning button again. An image is acquired by each operation.

However, restricted by the volume of the scanner, large area image scanning needs times of image-capturing operations and process of image synthesis to acquire a complete large area image. During times of image-capturing operations, the scanning button has to be pressed each time of starting and finishing the operation. Before the next operation, the scanner is set to a certain position. If the certain position is too far from the previous position, part of the image is not captured effectively. If the certain position is too close from the previous position, the number of times taken by the image-capturing operation is increased.

Therefore, there is a need of providing an image capture method in order to reduce the number of times and time taken by the image-capturing operation and solve the above drawbacks.

### SUMMARY OF THE INVENTION

An object of the present invention provides an image capture method in order to solve the drawbacks of the conventional technologies.

Another object of the present invention provides an image capture method. The image capturing-operation is performed continuously according to an image capture device moved along a specific route including several directions. Consequently, the number of times and time taken by the image-capturing operation are reduced and a complete image is captured effectively.

Another object of the present invention provides an image capture method. A coordinate value is acquired by the optical mouse sensor after each time interval, a slope is acquired according to a calculation of two coordinate values acquired at two adjacent time points, and a direction judging value is acquired according to an absolute value of the slope. The direction judging value is compared with a threshold value to judge moving direction, whether the capturing image is required, and whether the image is stored. The position information is provided for image synthesis, thereby enhancing the efficiency and the quality of image synthesis.

A further object of the present invention provides an image capture method. Through the allowable range of angles between the first direction, the second direction, the third direction and the forth direction, and the relationship of the length of the image capture device with the first displacement, the second displacement, the third displacement and the forth displacement, the moving direction and the displacement of the image capture device moved by a user could be controlled less accurately. The user could acquire good experience according to instinctive control, and also benefits to the image-capturing operation performed by the image capture device.

In accordance with an aspect of the present invention, there is provided an image capture method. The image capture method comprising steps of: (a) providing an image capture device and a medium; (b) performing an image-capturing operation to capture a capturing image of the medium; (c) moving the image capture device along a first direction on the medium; (d) judging whether the image-capturing operation is performed continuously; (e) moving the image capture device along a second direction on the medium, wherein an angle between the first direction and the second direction is ranged from 75 to 105 degrees; (f) moving the image capture device along a third direction on the medium, wherein an angle between the second direction and the third direction is ranged from 75 to 105 degrees; (g) judging whether the image-capturing operation is performed continuously; (h) moving the image capture device along a fourth direction on the medium, wherein an angle between the third direction and the fourth direction is ranged from 75 to 105 degrees; and (i) finishing the image-capturing operation; wherein if a judging result of the step (d) indicates that the image-capturing operation is performed continuously, the step (e) to the step (g) is performed; if the judging result of the step (d) indicates that the image-capturing operation is not performed continuously, the step (i) is performed; if a judging result of the step (g) indicates that the image-capturing operation is performed continuously, the step (h) is performed, and the step (c) and the step (d) are repeatedly done; and if the judging result of the step (g) indicates that the image-capturing operation is not performed continuously, the step (i) is performed.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of an image capture device using an image capture method of the present invention;

FIG. 2 schematically illustrates the image capture method according to an embodiment of the present invention;

FIG. 3 is a flowchart of an image capture method according to an embodiment of the present invention; and

FIG. 4 schematically illustrates the coordinate values and the slopes acquired by the optical mouse sensor used in the image capture method of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

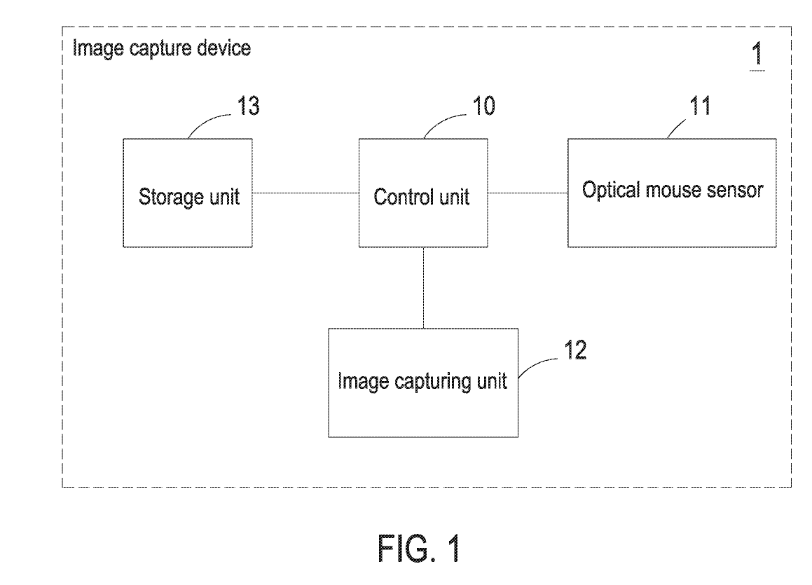

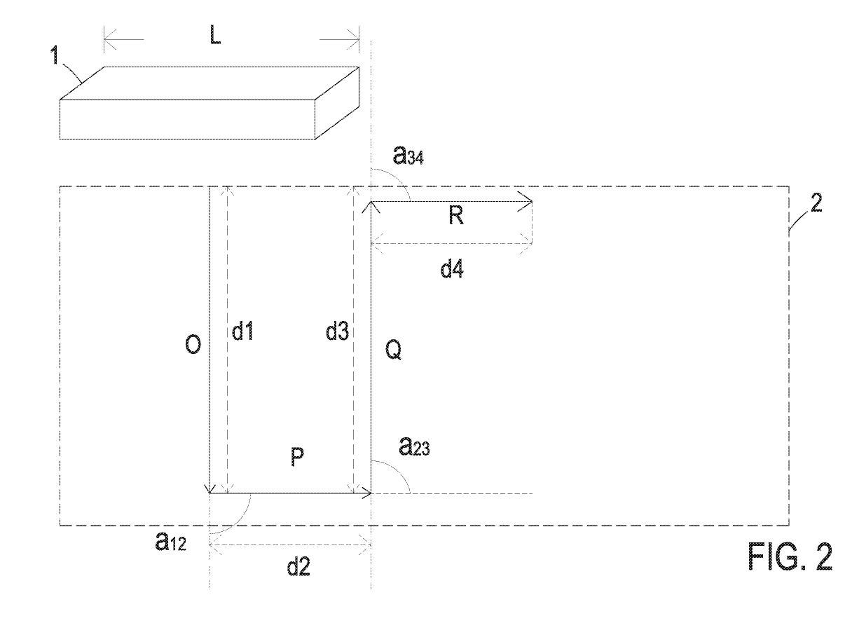

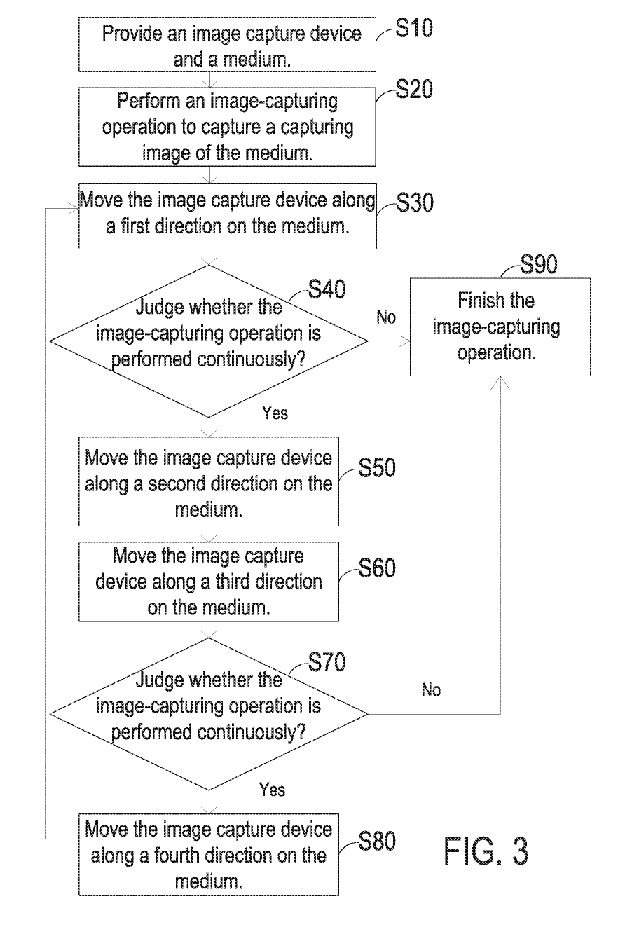

FIG. 1 schematically illustrates the architecture of an image capture device using an image capture method of the present invention. FIG. 2 schematically illustrates the image capture method according to an embodiment of the present invention. FIG. 3 is a flowchart of an image capture method according to an embodiment of the present invention. Please refer to FIGS. 1, 2 and 3. The image capture method comprises the following steps. Firstly, in a step S10, an image capture device 1 and a medium 2 are provided, wherein an example of the image capture device 1 includes but is not limited to a handy scanner. The image capture device 1 comprises a control unit 10, an optical mouse sensor 11 and an image capturing unit 12. The control unit 10 is electrically connected with the optical mouse sensor 11 and the image capturing unit 12. The optical mouse sensor 11 is configured to acquire a position information of the image capture device 1, and the image capturing unit 12 is configured to capture the capturing image of the medium 2. In an embodiment, the image capturing unit 12 includes but not limited to contact image sensor (CIS) or a charge-coupled device (CCD).

Then, in a step S20, an image-capturing operation is performed. An example of starting the image-capturing operation is pressing an image capturing button, but is not limited. Then, in the step S30, the image capture device 1 is moved along a first direction O on the medium 2. That is, the image capture device 1 is moved along the scanning direction to perform the image-capturing operation. Then, in a step S40, judge whether the image-capturing operation is performed continuously. An example of the judging is implemented by a user or according to the control unit 10 of the image capture device 1, but is not limited. If a judging result of the step S40 indicates that the image-capturing operation is performed continuously, a step S50 is performed. In the step S50, the image capture device 1 is moved along a second direction P on the medium 2, wherein an angle a₁₂ between the second direction P and the first direction O is ranged from 75 to 105 degrees. Then, in a step S60, the image capture device 1 is moved along a third direction Q on the medium 2, wherein an angle a₂₃ between the third direction Q and the second direction P is ranged from 75 to 105 degrees. Then, in a step S70, judge whether the image-capturing operation is performed continuously. An example of the judging is implemented by a user or according to the control unit 10 of the image capture device 1, but is not limited. If a judging result of the step S70 indicates that the image-capturing operation is performed continuously, a step S80 is performed, and the step S30 and the step S40 are repeatedly done. In the step S80, the image capture device 1 is moved along a fourth direction R on the medium 2, wherein an angle a₃₄ between the fourth direction R and the third direction Q is ranged from 75 to 105 degrees.

In some embodiments, if the judging result of the step S40 indicates that the image-capturing operation is not performed continuously, the step S90 is performed. That is, the image-capturing operation is finished. An example of finishing the image-capturing operation is pressing an image capturing button again, but is not limited. On the other hand, if the judging result of the step S70 indicates that the image-capturing operation is not performed continuously, the step S90 is performed, and the image-capturing operation is finished.

In brief, since in the image capture method of the present invention, the image capturing-operation is performed continuously according to the image capture device 1 moved along a specific route including several directions. For example, one capturing-operation is performed continuously according to the image capture device 1 moved along a U-shaped route, but is not limited. Consequently, the number of times and time taken by the image-capturing operation are reduced and a complete image is captured effectively.

According to the present invention, the image capture device 1 is moved along the first direction O on the medium 2 with a first displacement d1. The image capture device 1 is moved along the second direction P on the medium 2 with a second displacement d2, wherein the second displacement d2 is greater than half of the length L of the image capture device 1, and less than the length L of the image capture device 1. That is to say that L/2<d2<L. The image capture device 1 is moved along the third direction Q on the medium 2 with a third displacement d3, wherein the third displacement d3 is 90% to 110% of the first displacement d1. The image capture device 1 is moved along the forth direction R on the medium 2 with a forth displacement d4, wherein the forth displacement d4 is greater than half of the length L of the image capture device 1, and less than the length L of the image capture device 1. That is to say that L/2<d4<L.

It is noted that the present invention provides an image capture method while the image-capturing operation is moved along a route similar to continuous U-shaped and inverted U-shaped. Because the image capture device 1 is controlled by a user, the moving direction could not be controlled accurately each time the image capture device 1 is moved along the first direction O, the second direction P, the third direction Q, and the forth direction R on the medium 2. Each displacement of the image capture device 1 is also hard to be controlled, so the present invention introduces the designs of the angle a₁₂ between the second direction P and the first direction O is ranged from 75 to 105 degrees, the angle a₂₃ between the third direction Q and the second direction P is ranged from 75 to 105 degrees, and the angle a₃₄ between the forth direction R and the third direction Q is ranged from 75 to 105 degrees. The user could acquire good experience according to instinctive control. Further, in the image capture method of the present invention, the second displacement d2 is greater than half of the length L of the image capture device 1, and less than the length L of the image capture device 1. The third displacement d3 is 90% to 110% of the first displacement d1. The forth displacement d4 is greater than half of the length L of the image capture device 1, and less than the length L of the image capture device 1. Consequently, the image capture method of the present invention benefits to the image-capturing operation and the image synthesis performed by the image capture device 1, and a convenient image capture method could be provided to the user.

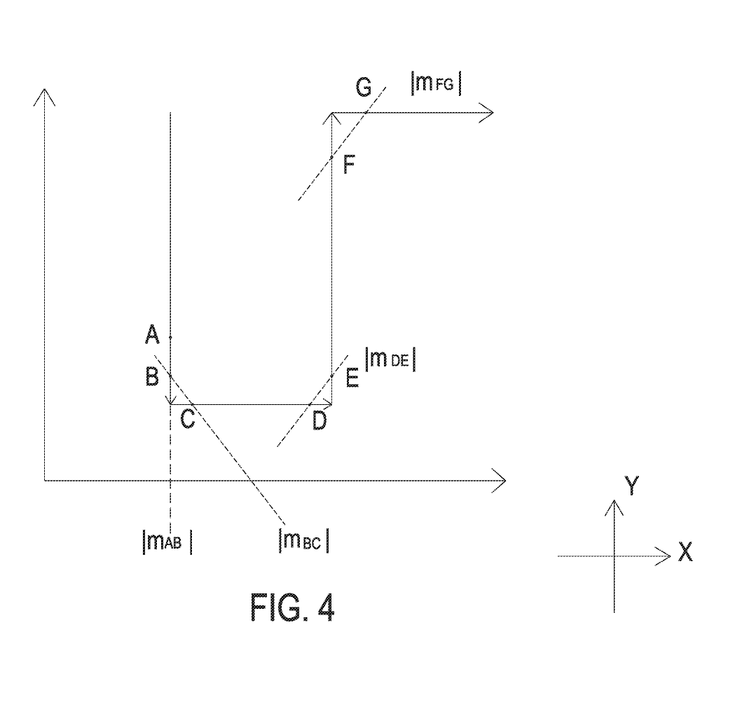

FIG. 4 schematically illustrates the coordinate values and the slopes acquired by the optical mouse sensor used in the image capture method of the present invention. Please refer to FIG. 4 with FIGS. 1 and 2. In FIG. 4, the horizontal direction is defined as X-axis, the vertical direction is defined as Y-axis, and the coordinate value is defined as (X,Y), wherein the coordinate value could be provided for image synthesis as position information. A coordinate value is acquired by the optical mouse sensor 11 after each time interval T, wherein an example of the time interval T is but not limited to 0.002 second. A direction judging value |m| is acquired according to an absolute value of the slope m calculated by a slope formula : m=(y2−y1)/(x2−x1).

A threshold value M is set by the optical mouse sensor 11, wherein an example of the threshold value M is but not limited to 0.5. When the direction judging value |m| is changed from higher than the threshold value M to lower than the threshold value M, or changed from lower than the threshold value M to higher than the threshold value M, judges moving direction of the image capture device 1 is changed.

If the direction judging value |m| is higher than the threshold value M, judges the capturing image captured by the image capture device 1 is a required image, and stores the capturing image in the image capture device 1. For example, stores the capturing image in a storage unit 13 of the image capture device 1, wherein the storage unit 13 is electrically connected to the control unit 10. If the direction judging value |m| is lower than the threshold value M, judges the capturing image captured by the image capture device 1 is not a required image, and discards the capturing image.

According to the present invention, in the step S30, when the image capture device 1 is moved along the first direction O on the medium 2, a coordinate value is acquired by the optical mouse sensor 11 after each time interval T, a slope m is acquired according to a calculation of two coordinate values acquired at two adjacent time points, and a direction judging |m| value is acquired according to an absolute value of the slope m. The direction judging value |m| is compared with a threshold value M. In the case that the direction judging value |m| is higher than the threshold value M, judges the capturing image captured by the image capture device 1 is a required image, and stores the capturing image.

For example, as shown in FIG. 4, a coordinate value (X1,Y1) is acquired at a first coordinate point A by the optical mouse sensor 11, and another coordinate value (X2,Y2) is acquired at a second coordinate point B after a time interval T. A slope m_{AB} between the first coordinate point A and the second coordinate point B is acquired according to a calculation m_{AB}=(Y2−Y1)/(X2−X1). In the case that the direction judging value |m_{AB}|=|(Y2−Y1)/(X2−X1)| is higher than the threshold value M, judges the image capture device 1 is still moved along the first direction O, the moving direction is not changed, the capturing image captured by the image capture device 1 is a required image, and stores the capturing image.

According to the present invention, in the step S50, when the image capture device 1 is moved along the second direction P on the medium 2, a coordinate value is acquired by the optical mouse sensor 11 after each time interval T, a slope m is acquired according to a calculation of two coordinate values acquired at two adjacent time points, and a direction judging |m| value is acquired according to an absolute value of the slope m. The direction judging value |m| is compared with a threshold value M. In the case that the direction judging value |m| is lower than the threshold value M, judges the capturing image captured by the image capture device 1 is not a required image, and discards the capturing image.

For example, as shown in FIG. 4, the coordinate value (X2,Y2) is acquired at the second coordinate point B by the optical mouse sensor 11, and another coordinate value (X3,Y3) is acquired at a third coordinate point C after a time interval T. A slope m_{BC} between the second coordinate point B and the third coordinate point C is acquired according to a calculation m_{BC}=(Y3−Y2)/(X3−X2). In the case that the direction judging value |m_{BC}|=|(Y3−Y2)/(X3−X2)| is changed from higher than the threshold value M to lower than the threshold value M, judges moving direction of the image capture device 1 is changed from the first direction O to the second direction P, the capturing image captured by the image capture device 1 is not a required image, and discards the capturing image.

According to the present invention, in the step S60, when the image capture device 1 is moved along the third direction Q on the medium 2, a coordinate value is acquired by the optical mouse sensor 11 after each time interval T, a slope m is acquired according to a calculation of two coordinate values acquired at two adjacent time points, and a direction judging |m| value is acquired according to an absolute value of the slope m. The direction judging value |m| is compared with a threshold value M. In the case that the direction judging value |m| is higher than the threshold value M, judges the capturing image captured by the image capture device 1 is a required image, and stores the capturing image.

For example, as shown in FIG. 4, a coordinate value (X4,Y4) is acquired at a forth coordinate point D by the optical mouse sensor 11, and another coordinate value (X5,Y5) is acquired at a fifth coordinate point E after a time interval T. A slope m_{DE} between the forth coordinate point D and the fifth coordinate point E is acquired according to a calculation m_{DE}=(Y5−Y4)/(X5−X4). In the case that the direction judging value |m_{DE}|=|(Y5−Y4)/(X5−X4)| is changed from lower than the threshold value M to higher than the threshold value M, judges moving direction of the image capture device 1 is changed from the second direction P to the third direction Q, the capturing image captured by the image capture device 1 is a required image, and stores the capturing image.

According to the present invention, in the step S80, when the image capture device 1 is moved along the forth direction R on the medium 2, a coordinate value is acquired by the optical mouse sensor 11 after each time interval T, a slope m is acquired according to a calculation of two coordinate values acquired at two adjacent time points, and a direction judging |m≡1 value is acquired according to an absolute value of the slope m. The direction judging value |m| is compared with a threshold value M. In the case that the direction judging value |m| is lower than the threshold value M, judges the capturing image captured by the image capture device 1 is not a required image, and discards the capturing image.

For example, as shown in FIG. 4, a coordinate value (X6,Y6) is acquired at a sixth coordinate point F by the optical mouse sensor 11, and another coordinate value (X7,Y7) is acquired at a seventh coordinate point G after a time interval T. A slope m_{DE} between the sixth coordinate point F and the seventh coordinate point G is acquired according to a calculation m_{FG}=(Y3−Y2)/(X3−X2). In the case that the direction judging value |m_{FG}|=|(Y3−Y2)/(X3−X2)| is changed from higher than the threshold value M to lower than the threshold value M, judges moving direction of the image capture device 1 is changed from the third direction Q to the forth direction R, the capturing image captured by the image capture device 1 is not a required image, and discards the capturing image.

In brief, since in the image capture method of the present invention, a coordinate value is acquired by the optical mouse sensor after each time interval, a slope is acquired according to a calculation of two coordinate values acquired at two adjacent time points, and a direction judging value is acquired according to an absolute value of the slope. The direction judging value is compared with a threshold value to judge moving direction, whether the capturing image is required, and whether the image is stored. The position information is provided for image synthesis, thereby enhancing the efficiency and the quality of image synthesis.

From the above descriptions, the present invention provides an image capture method in order to solve the drawbacks of the conventional technologies. In the image capture method of the present invention, the image capturing-operation is performed continuously according to an image capture device moved along a specific route including several directions. Consequently, the number of times and time taken by the image-capturing operation are reduced and a complete image is captured effectively. Also, a coordinate value is acquired by the optical mouse sensor after each time interval, a slope is acquired according to a calculation of two coordinate values acquired at two adjacent time points, and a direction judging value is acquired according to an absolute value of the slope. The direction judging value is compared with a threshold value to judge moving direction, whether the capturing image is required, and whether the image is stored. The position information is provided for image synthesis, thereby enhancing the efficiency and the quality of image synthesis.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image capture method, comprising steps of:
(a) providing an image capture device and a medium;
(b) performing an image-capturing operation to capture a capturing image of the medium;
(c) moving the image capture device along a first direction on the medium;
(d) judging whether the image-capturing operation is performed continuously;
(e) moving the image capture device along a second direction on the medium, wherein an angle between the second direction and the first direction is ranged from 75 to 105 degrees;
(f) moving the image capture device along a third direction on the medium, wherein an angle between the third direction and the second direction is ranged from 75 to 105 degrees;
(g) judging whether the image-capturing operation is performed continuously;
(h) moving the image capture device along a fourth direction on the medium, wherein an angle between the forth direction and the third direction is ranged from 75 to 105 degrees; and
(i) finishing the image-capturing operation;
wherein if a judging result of the step (d) indicates that the image-capturing operation is performed continuously, the step (e) to the step (g) is performed; if the judging result of the step (d) indicates that the image-capturing operation is not performed continuously, the step (i) is performed; if a judging result of the step (g) indicates that the image-capturing operation is performed continuously, the step (h) is performed, and the step (c) and the step (d) are repeatedly done; and if the judging result of the step (g) indicates that the image-capturing operation is not performed continuously, the step (i) is performed.

2. The image capture method according to claim 1, wherein the image capture device is a handy scanner and comprises:
a control unit configured to control the operations of the image capture device;
an optical mouse sensor, electrically connected with the control unit and configured to acquire a position information of the image capture device;
an image capturing unit, electrically connected with the control unit and configured to capture the capturing image of the medium; and
a storage unit, electrically connected with the control unit and configured to store the position information and the capturing image.

3. The image capture method according to claim 1, wherein in the step (c), the image capture device is moved along the first direction on the medium with a first displacement.

4. The image capture method according to claim 3, wherein in the step (f), the image capture device is moved along the third direction on the medium with a third displacement, wherein the third displacement is 90% to 110% of the first displacement.

5. The image capture method according to claim 1, wherein in the step (e), the image capture device is moved along the second direction on the medium with a second displacement, wherein the second displacement is greater than half of the length of the image capture device, and less than the length of the image capture device.

6. The image capture method according to claim 1, wherein in the step (h), the image capture device is moved along the forth direction on the medium with a forth displacement, wherein the forth displacement is greater than half of the length of the image capture device, and less than the length of the image capture device.

7. The image capture method according to claim 1, wherein in the step (b) and the step (i), starting and finishing the image-capturing operation are controlled by pressing an image capture button of the image capture device.

8. The image capture method according to claim 2, wherein in the step (c), the step (e), the step (f) and the step (h), a coordinate value is acquired by the optical mouse sensor after each time interval, a slope is acquired according to a calculation of two coordinate values acquired at two adjacent time points, and a direction judging value is acquired according to an absolute value of the slope.

9. The image capture method according to claim 8, wherein when the direction judging value is changed from higher than a threshold value to lower than the threshold value, or changed from lower than the threshold value to higher than the threshold value, judges moving direction of the image capture device is changed.

10. The image capture method according to claim 9, wherein if the direction judging value is higher than the threshold value, judges the capturing image captured by the image capture device is a required image, and stores the capturing image in the image capture device;
wherein if the direction judging value is lower than the threshold value, judges the capturing image captured by the image capture device is not a required image, and discards the capturing image.
